(19) United States
(12) Patent Application Publication
(10) Pub. No.: US 2026/0337023 A1
(43) Pub. Date: Oct. 29, 2026

(54) Method of Hydrogen Production

(71) Applicant: Air Products and Chemicals, Inc., Allentown, PA (US)

(72) Inventors: Sonia Farrokhpanah, Surbiton (GB); Paul Higginbotham, Surrey (GB); Kristin Anna Hirsch, Macungie, PA (US)

(73) Assignee: Air Products and Chemicals, Inc., Allentown, PA (US)

(21) Appl. No.: 19/187,064

(22) Filed: Apr. 23, 2025

(51) Int. Cl. C01B 3/48; C01B 3/38

(52) U.S. Cl. CPC C01B 3/48; C01B 3/38; C01B 2203/0288; C01B 2203/0475

(57) ABSTRACT

Methods directed to producing hydrogen from a syngas stream while capturing carbon dioxide, comprising a reactor to convert hydrocarbons to syngas, one or more water gas shift units to convert carbon monoxide and water to hydrogen and carbon dioxide, and a carbon dioxide capture system. The carbon dioxide capture system may produce a non-condensable stream that may be utilized to control the temperature in the one or more water gas shift reactors and prevent failure by means such as metal dusting.

### BACKGROUND OF THE INVENTION

Industrial processes such as reforming hydrocarbon feeds to produce hydrogen and syngas will need to capture carbon dioxide (CO2) to mitigate the effects of climate change. Oxygen-fired reforming methods can achieve relatively high carbon capture compared to conventional steam/hydrocarbon reforming methods since a majority of the CO2 produced in the oxygen-fired reforming methods can be recovered and purified from the high-pressure syngas stream using processes such as adsorption followed by partial condensation of the CO2 in the tail gas stream. Oxygen-fired reforming processes such as partial oxidation (POX) may also produce hydrogen at a larger scale than other technologies such as steam methane reforming.

### SUMMARY OF THE INVENTION

Disclosed herein is an example of methods for producing a hydrogen stream and a carbon dioxide stream from a hydrocarbon feed by oxygen-fired reforming, water gas shift reaction, adsorption, and partial condensation of the tail gas stream. The method may include recycling at least a portion of a non-condensable stream from the partial condensation step to the feed of the first water gas shift reactor to reduce the outlet temperature of the first water gas shift reactor and reduce the risk of failure by means such as metal dusting. The method may include controlling the outlet temperature of the first water gas shift reactor by increasing or decreasing the fraction of the non-condensable stream recycled to the first water gas shift reactor and/or by the amount of syngas bypassed around the first water gas shift reactor.

### BRIEF DESCRIPTION OF DRAWINGS

These drawings illustrate certain aspects of some of the embodiments of the present disclosure and should not be used to limit or define the disclosure:

FIG. 1 is a schematic view depicting an embodiment of a partial oxidation process according to one or more aspects of the present disclosure.

### DETAILED DESCRIPTION OF THE INVENTION

The ensuing detailed description provides preferred exemplary embodiments only, and is not intended to limit the scope, applicability, or configuration of the disclosure. Rather, the ensuing detailed description of the preferred exemplary embodiments will provide those skilled in the art with an enabling description for implementing the preferred exemplary embodiments of the disclosure. Various changes may be made in the function and arrangement of elements without departing from the spirit and scope of the disclosure, as set forth in the appended claims.

The articles "a" or "an" as used herein mean one or more when applied to any feature in embodiments of the present disclosure described in the specification and claims. The use of "a" and "an" does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The term “and/or” placed between a first entity and a second entity includes any of the meanings of (1) only the first entity, (2) only the second entity, or (3) the first entity and the second entity. The term “and/or” placed between the last two entities of a list of 3 or more entities means at least one of the entities in the list including any specific combination of entities in this list. For example, “A, B and/or C” has the same meaning as “A and/or B and/or C” and comprises the following combinations of A, B and C: (1) only A, (2) only B, (3) only C, (4) A and B but not C, (5) A and C but not B, (6) B and C but not A, and (7) A and B and C.

The term “plurality” means “two or more than two.”

The adjective “any” means one, some, or all, indiscriminately of quantity.

The phrase “at least a portion” means “a portion or all.” The “at least a portion of a stream” has the same composition, with the same concentration of each of the species, as the stream from which it is derived.

As used herein, “first,” “second,” “third,” etc. are used to distinguish among a plurality of steps and/or features, and is not indicative of the total number, or relative position in time and/or space, unless expressly stated as such.

The terms “depleted” or “lean” mean having a lesser mole percent concentration of the indicated component than the original stream from which it was formed. “Depleted” and “lean” do not necessarily mean that the stream is completely lacking the indicated component.

The terms “rich” or “enriched” mean having a greater mole percent concentration of the indicated component than the original stream from which it was formed.

“Downstream” and “upstream” refer to the intended flow direction of the process fluid transferred. If the intended flow direction of the process fluid is from the first device to the second device, the second device is downstream of the first device. In case of a recycle stream, downstream and upstream refer to the first pass of the process fluid.

The present disclosure is directed to methods for producing a hydrogen stream and a carbon dioxide stream from a hydrocarbon feed by oxygen-fired reforming, adsorption, and partial condensation of the tail gas stream.

In accordance with the present embodiments, a feedstock comprising hydrocarbons may be reformed in an oxygen-fired process to produce a syngas stream. The feedstock may comprise impurities such as sulfur. The feedstock may comprise steam. The feedstock may comprise carbon dioxide. The oxygen-fired process may comprise a POX reactor. The oxygen-fired process may comprise an auto-thermal reformer (ATR). The oxygen-fired process may comprise a gasifier with liquid and/or solid feed. The syngas may be cooled and as a result produce useful heat such as by steam generation. The syngas may be cleaned of impurities such as soot, ammonia, HCN, and acid gases.

The syngas may be fed to one or more water gas shift (WGS) reactors in which water and carbon monoxide react to form hydrogen and carbon dioxide, producing a shifted syngas stream. The syngas may have water in liquid or vapor phase added prior to any of the one or more WGS reactors. The one or more WGS reactors may be arranged in series such that the exit temperature of each successive WGS reactor is lower to move the chemical reaction equilibrium towards more hydrogen production. The one or more WGS reactors may be arranged with a high temperature shift (HTS) followed by a medium temperature shift (MTS) followed by a low temperature shift (LTS). The one or more WGS reactors may be configured to operate under hard shift, in which the conversion of carbon monoxide is high and low concentrations of carbon monoxide slip to the outlet of the one or more WGS reactors. The one or more WGS reactors may be configured to operate under loose shift, in which the conversion of carbon monoxide is lower and higher concentrations of carbon monoxide slip to the outlet of the one or more WGS reactors. When operating under loose shift, the one or more WGS reactors may omit the LTS.

HTS reactors may be defined as having inlet temperatures ranging from 550 to 650 °F. MTS reactors may be defined as having inlet temperatures ranging from 350 to 450 °F. LTS reactors may be defined as having inlet temperatures ranging from 350 to 450 °F. While MTS and LTS reactors share an inlet temperature range, the inlet CO concentration may be higher for an MTS reactor than an LTS reactor, resulting in a greater exotherm and higher outlet temperature for an MTS reactor.

The shifted syngas may be purified to produce a hydrogen-enriched product stream and a hydrogen-depleted tail gas stream. The purification may be accomplished using an adsorption system. The purification may be accomplished using a pressure-swing adsorption (PSA) system. The PSA system may be operated to produce a hydrogen-enriched product stream with high or low purity. The shifted syngas may have at least a portion of the CO2 removed by partial condensation prior to purification by adsorption, especially in the case where the shifted syngas is available at high pressure.

The hydrogen-depleted tail gas stream may be compressed. The hydrogen-depleted tail gas stream may be dehydrated by means including partial condensation to form an aqueous bottoms stream (especially when cooling after a stage of compression), absorption, and/or adsorption to produce a dehydrated tail gas stream. The hydrogen-depleted tail gas stream may be dehydrated using means such as a temperature swing adsorption (TSA) unit as the final step. The dew point temperature of the dehydrated tail gas stream may be reduced to prevent liquid or solid phases from forming in the downstream carbon capture process. The dehydrated CO2 stream may comprise less than 100 ppmv water, or less than 20 ppmv water, or less than 1 ppmv water, or less than 0.1 ppmv water.

The dehydrated tail gas stream may be compressed to a pressure greater than 10 bar, or greater than 20 bar, or greater than 30 bar, or greater than 35 bar, or greater than 37 bar, or ranging from 30 to 80 bar, or ranging from 30 to 60 bar. The dehydrated tail gas stream may be cooled and at least partially condensed in a first heat exchanger to produce a first CO2-enriched liquid stream and a first CO2-depleted vapor stream. The liquid and vapor streams may be separated by one or more flash vessels and/or columns. The columns may comprise trays and/or packing. The first CO2-enriched liquid stream may be expanded across a pressure reducer such as a valve to provide refrigeration duty to cool to the dehydrated tail gas stream. The first CO2-depleted vapor stream may be further cooled and partially condensed to produce a cold CO2-depleted non-condensable stream and a cold CO2-enriched liquid stream. The first CO2-depleted vapor stream may be cooled in the first heat exchanger or a second heat exchanger. Heat exchangers may be combined to save on capital costs and/or efficiency or split to simplify operation. The non-condensable and liquid streams may be separated by one or more flash vessels and/or columns. The columns may comprise trays and/or packing. The cold CO2-enriched liquid stream may be warmed and/or reduced in pressure in any order to provide refrigeration to the heat exchangers. After warming and/or expansion, the cold CO2-enriched liquid stream and the first CO2-enriched liquid stream may be combined to form a CO2 product stream. The cold non-condensable stream may be warmed to produce a non-condensable stream and provide refrigeration to the heat exchangers.

The non-condensable stream may be recycled to improve the overall recovery of hydrogen and/or carbon dioxide. The non-condensable stream may comprise less than 30% CO2 by volume. At least a first portion of the non-condensable stream may be divided to form an HTS recycle stream and fed to the HTS. At least a second portion of the non-condensable stream may be divided to form an MTS recycle stream and fed to the MTS. At least a third portion of the non-condensable stream may be divided to form an LTS recycle stream and fed to the LTS. At least a fourth portion of the non-condensable stream may be divided to form a PSA recycle stream and fed to the PSA. Despite use of ordinal numbers to denote the portions of the non-condensable stream, any combination of recycle destinations for the non-condensable stream are possible. For example, the non-condensable stream may be divided into an HTS recycle stream and an LTS recycle stream without requiring division to form an MTS recycle stream.

The non-condensable stream may be recycled to the shift reactor whose feed composition most closely matches the composition of the non-condensable stream, which would be thermodynamically advantageous. In at least some embodiments the non-condensable stream may be the closest compositional match to a shifted syngas stream entering the LTS, and therefore no portions of the non-condensable stream would be divided to form an HTS recycle stream, MTS recycle stream, or PSA recycle stream. The HTS recycle stream may be used to control the temperature of the HTS. Because the WGS reaction is exothermic, the temperature in the HTS may increase above a metal dusting limit temperature. The metal dusting temperature may be 850 °F, or 950 °F, or 1050 °F. Above the metal dusting limit temperature, metals such as carbon steel, stainless steel, and various nickel-based alloys may react with carbon monoxide at a sufficiently rapid rate to weaken the material and increase the risk of failure. Combining the syngas entering the HTS with the HTS recycle gas stream may reduce the risk of metal dusting by reducing the concentration of carbon monoxide and thus reducing the amount of the exothermic WGS reaction in the HTS. This provides an unexpected benefit, despite a larger difference in composition between the HTS recycle stream and the feed to the HTS compared to the HTS recycle stream and the feed to the LTS meaning the recycle to the HTS is thermodynamically less efficient. The HTS recycle stream may be added to the HTS at a point downstream of the point that the syngas enters the HTS in order to reduce the amount of contact time between the HTS recycle stream and the shift catalyst. The reduction in contact time will reduce the extent of WGS shift reaction and therefore the temperature increase from WGS in the HTS recycle stream.

The ratio of the flow rate of the HTS recycle stream to the total flow rate of the carbon dioxide-lean retentate stream or the non-condensable stream may be increased to decrease the temperature of the HTS. The ratio of the flow rate of the HTS recycle stream to the total flow rate of the carbon dioxide-lean retentate stream or the non-condensable stream may be decreased to increase the temperature of the HTS. The temperature of the HTS may be defined as the outlet temperature of HTS, or the temperature of a first shifted syngas stream exiting the HTS.

The temperature of the HTS recycle stream may be increased to increase the temperature of the HTS, or the temperature of the HTS recycle stream may be decreased to decrease the temperature of the HTS. The temperature of the HTS recycle stream may be controlled by indirect heat exchange against a hot stream such as the first shifted syngas stream. In at least some embodiments, the HTS recycle stream may be combined with a saturated steam stream and the syngas stream upstream of the HTS. In order to prevent condensation of liquid water in the syngas line, a two-stage economizer may preheat the syngas stream in a first economizer stage, then combine with the HTS recycle stream and the saturated steam stream, and then preheat the resulting mixture in a second economizer stage. One or both stages of the two-stage economizer may be heated by indirect heat exchange against the first shifted syngas stream. In at least some embodiments, superheated steam may be used in addition to or in place of saturated steam. Superheated steam may reduce or eliminate the need for preheating in an economizer at the cost of using a product that can be potentially exported.

The temperature of the HTS may also be controlled by bypassing a portion of the syngas stream around the HTS. The ratio of the bypassed portion of the syngas stream to the total flow rate of the syngas stream may be increased to decrease the temperature of the HTS. The ratio of the bypassed portion of the syngas stream to the total flow rate of the syngas stream may be decreased to increase the temperature of the HTS.

Some conditions may increase the risk of metal dusting. For example, when the overall steam to dry gas ratio (SDGR, where dry gas is defined as all species in the gas phase except steam) in the syngas and the HTS recycle stream entering the HTS is less than 2.0, or less than 1.8, or less than 1.6, or less than 1.4, or less than 1.2, or less than 1.0, or less than 0.85, there may be an increased rate of metal dusting. When the CO concentration in the syngas is greater than 15 vol%, or greater than 20 vol%, or greater than 30 vol%, or greater than 50 vol%, or greater than 60 vol%, or ranges from 30 vol% to 60 vol%, there may be an increased rate of metal dusting. When the total concentration of sulfur species in the syngas is less than 20 ppmv, or less than 10 ppmv, or less than 5 ppmv, or less than 2 ppmv, there may be an increased rate of metal dusting. When the concentration of water vapor in the syngas ranges from 20% to 50% by volume, or from 40% to 52% by volume, there may be an increased rate of metal dusting. In all of the above references to the composition of the syngas stream entering the HTS, the syngas stream includes any recycle stream combined with the syngas stream upstream of the HTS.

At least a fifth portion of the non-condensable stream may be divided to form a purge stream and may be separated in a membrane separation system which may comprise a single membrane stage or a plurality of membrane stages in series and/or parallel. The purge stream may be separated by selective permeation into a carbon dioxide-enriched permeate stream and a carbon dioxide-lean retentate stream. Carbon dioxide may selectively permeate across the membrane faster than species such as nitrogen, argon, and/or carbon monoxide. In at least some example implementations, the higher solubility of carbon dioxide in the membrane material results in a faster permeation rate than similar-sized molecules with lower solubility such as nitrogen. The carbon dioxide-enriched permeate stream may be combined with the hydrogen-depleted tail gas stream. The carbon dioxide-retentate may be vented to purge the system of light species that may otherwise accumulate in recycle loops. The carbon dioxide-retentate may be combusted to recover heat, such as by steam generation and/or superheating.

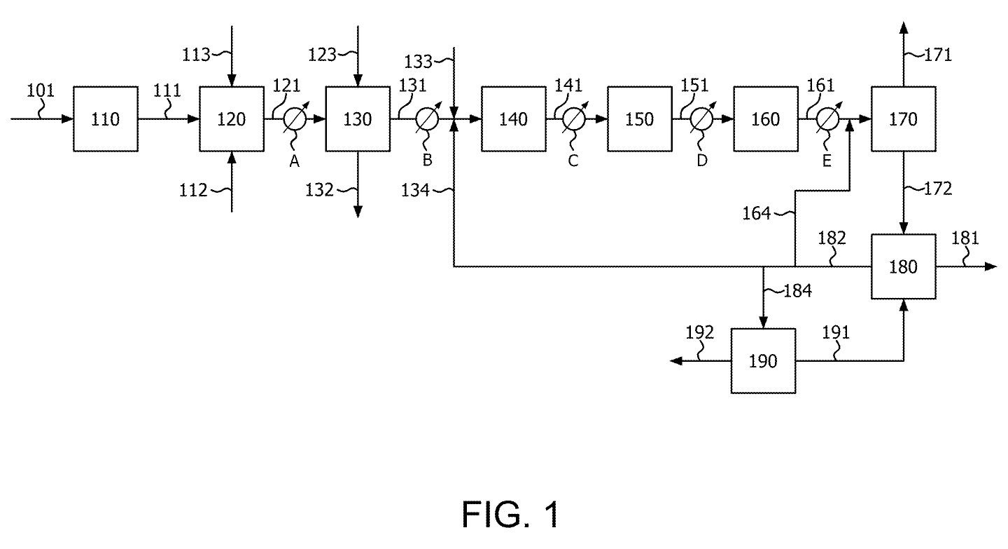

FIG. 1 is a schematic view depicting an embodiment of a partial oxidation process according to one or more aspects of the present disclosure. Raw hydrocarbon stream 101 enters pretreatment section 110 to produce treated hydrocarbon stream 111. Treated hydrocarbon stream 111, oxidant stream 112, and optional POX reactor steam stream 113 enter POX reactor 120 where they react to produce first syngas stream 121. Heat may be recovered from first syngas stream 121 in heat exchange network A, for example to produce steam, superheat steam, or preheat process streams. Heat exchange network A may comprise any number of heat exchangers to recover heat in the most efficient and/or cost effective manner. First syngas stream 121 then may enter scrubber 130 in which a wash stream 123 may remove impurities such as soot, ammonia, HCN, and acid gases from first syngas stream 121 to produce a second syngas stream 131 depleted in impurities and a spent wash stream 132 enriched in impurities. Heat may be recovered from second syngas stream 131 in heat exchange network B as described for first syngas stream 121. Second syngas stream 131 may be combined with optional WGS reactor steam stream 133 prior to entering HTS reactor 140. Second syngas stream 131 may be combined with first recycle stream 134 prior to entering HTS reactor 140. Alternatively, WGS reactor steam stream 133 and/or recycle stream 134 may enter HTS reactor 140 through dedicated inlet ports. Carbon monoxide and water vapor in second syngas stream 131 react to form carbon dioxide and hydrogen in HTS reactor 140, producing first shifted syngas stream 141. Heat may be recovered from first shifted syngas stream 141 in heat exchange network C as described for first syngas stream 121 prior to entering MTS reactor 150. Carbon monoxide and water vapor in first shifted syngas stream 141 react to form carbon dioxide and hydrogen in MTS reactor 150, producing second shifted syngas stream 151. Heat may be recovered from second shifted syngas stream 151 in heat exchange network D as described for first syngas stream 121 prior to entering LTS reactor 160. Carbon monoxide and water vapor in second shifted syngas stream 151 react to form carbon dioxide and hydrogen in LTS reactor 160, producing third shifted syngas stream 161. Heat may be recovered from third shifted syngas stream 161 in heat exchange network E as described for first syngas stream 121 prior to entering PSA 170. All heat exchangers may represent multiple heat exchangers in series or parallel, as required for optimized heat recovery. In at least some embodiments, a heat exchanger cooling a syngas stream may comprise a vessel for removing condensate. Second recycle stream 164 may be combined with third shifted syngas stream 161 upstream of the PSA 170 or may be introduced to the PSA 170 via a separate inlet port. In at least some embodiments, second recycle stream 164 may be eliminated with all recycle flow directed to the first recycle stream 134. The PSA separates the third shifted syngas stream 161 and the optional second recycle stream 164 into a hydrogen product stream 171 and a tail gas 172. The tail gas 172 comprises CO2, H2, water, and unreacted species such as CH4 and CO, and may be separated in CO2 separator 180 to produce a carbon dioxide product stream 181 and a vent stream 182. In at least some embodiments the CO2 separator 180 comprises a dehydration section and a CO2 purification unit (CPU) (not shown). The vent stream may be divided into two or more fractions: the first recycle stream 134, the second recycle stream 164, and/or a purge stream 184. The purge stream 184 may be separated in a membrane section 190 comprising one or more stages of membranes in series or parallel to produce a CO2 separator return stream 191 and a second purge stream 192. The second purge stream may be depleted in carbon dioxide and/or hydrogen and may be vented, flared, or combusted depending on the concentration of flammable species.

Aspect 1: A method comprising reacting a feed stream comprising hydrocarbons with an oxidant comprising at least one of water, oxygen, and carbon dioxide to produce a first syngas stream comprising hydrogen, water, carbon monoxide, and carbon dioxide; reacting a second syngas stream in the presence of a first shift catalyst to produce a first shifted syngas stream enriched in hydrogen and carbon dioxide and depleted in water and carbon monoxide; reacting the first shifted syngas stream in the presence of a second shift catalyst to produce a second shifted syngas stream further enriched in hydrogen and carbon dioxide and depleted in water and carbon monoxide; separating a PSA feed stream to produce a hydrogen product stream enriched in hydrogen and a tail gas stream depleted in hydrogen; cooling the tail gas stream below a dew point temperature of the tail gas stream to produce a liquid stream enriched in carbon dioxide and a non-condensable stream depleted in carbon dioxide; and contacting at least a portion of the non-condensable stream with the first shift catalyst; wherein the second syngas stream comprises the first syngas stream or a stream derived from the first syngas stream; wherein the PSA feed stream comprises the second shifted syngas stream or a stream derived from the second shifted syngas stream.

Aspect 2: A method according to Aspect 1, further comprising combining a second portion of the non-condensable stream with the PSA feed stream prior to separation to produce the hydrogen product stream and the tail gas stream.

Aspect 3: A method according to Aspects 1 or 2, wherein a ratio of a flow rate of the at least a portion of the non-condensable stream contacted with the first shift catalyst to a total flow rate of the non-condensable stream is increased or decreased to decrease or increase a temperature of the first shifted syngas stream, respectively.

Aspect 4: A method according to Aspect 3, wherein the temperature of the first shifted syngas stream is maintained below a metal dusting limit temperature.

Aspect 5: A method according to any of Aspects 1 to 4, further comprising bypassing a portion of the second syngas stream around the first shift catalyst and combining the portion of the second syngas stream with the first shifted syngas stream prior to contacting with the second shift catalyst.

Aspect 6: A method according to Aspect 5, further comprising increasing or decreasing the portion of the second syngas stream bypassed around the first shift catalyst to decrease or increase a temperature of the first shifted syngas stream, respectively.

Aspect 7: A method according to any of Aspects 1 to 6, further comprising contacting at least a portion of the second shifted syngas stream with a third shift catalyst to produce a third shifted syngas stream; wherein the PSA feed stream comprises the third shifted syngas stream.

Aspect 8: A method according to any of Aspects 1 to 7, wherein an overall steam to dry gas ratio of the second syngas stream and the at least a portion of the non-condensable stream is less than 2.0.

Aspect 9: A method according to any of Aspects 1 to 8, further comprising heating the at least a portion of the non-condensable stream by indirect heat exchange against the first shifted syngas stream prior to contacting at least a portion of the non-condensable stream with the first shift catalyst.

Aspect 10: A method according to any of Aspects 1 to 9, further comprising compressing the tail gas stream prior to cooling to 10 bar.

Aspect 11: A method according to any of Aspects 1 to 10, further comprising dehydrating the tail gas stream prior to cooling to less than 100 ppmv water.

Aspect 12: A method according to any of Aspects 1 to 11, wherein the non-condensable stream comprises less than 30% CO2 by volume.

Aspect 13: A method according to any of Aspects 1 to 12, wherein the CO concentration of the second syngas stream is greater than 15%.

Aspect 14: A method according to any of Aspects 1 to 13, wherein the sulfur concentration of the second syngas stream is less than 20 ppmv.

Aspect 15: A method according to any of Aspects 1 to 14, wherein the combined water concentration of the second syngas stream and the at least a portion of the non-condensable stream ranges from 20% to 55% by volume.

Aspect 16: A method according to any of Aspects 1 to 15, further comprising removing a purge stream depleted in hydrogen from the at least a portion of the non-condensable stream by selective permeation prior to contacting with the first shift catalyst.

Aspect 17: A method according to any of Aspects 1 to 16, wherein the at least a portion of the non-condensable stream is initially contacted with the first shift catalyst at a point downstream of where the second syngas stream initially contacts the first shift catalyst.

Aspect 18: A method according to any of Aspects 1 to 17, wherein a temperature of the second syngas stream ranges from 550 ° F. to 650 ° F.

Aspect 19: A method comprising reacting a feed stream comprising hydrocarbons with an oxidant comprising at least one of water, oxygen, and carbon dioxide to produce a first syngas stream comprising hydrogen, water, carbon monoxide, and carbon dioxide; contacting the first syngas stream with a liquid wash stream to produce a second syngas stream; heating the second syngas stream by indirect heat exchange against a first shifted syngas stream to produce a heated syngas stream; combining the heated syngas stream with steam and a recycle stream to produce a combined syngas stream; reacting the combined syngas stream in the presence of a first shift catalyst to produce the first shifted syngas stream enriched in hydrogen and carbon dioxide and depleted in water and carbon monoxide; reacting the first shifted syngas stream in the presence of a second shift catalyst to produce a second shifted syngas stream further enriched in hydrogen and carbon dioxide and depleted in water and carbon monoxide; separating a PSA feed stream to produce a hydrogen product stream enriched in hydrogen and a tail gas stream depleted in hydrogen; and cooling the tail gas stream below a dew point temperature of the tail gas stream to produce a liquid stream enriched in carbon dioxide and a non-condensable stream depleted in carbon dioxide; wherein the recycle stream comprises at least a portion of the non-condensable stream; wherein the PSA feed stream comprises the second shifted syngas stream or a stream derived from the second shifted syngas stream.

Aspect 20: A method according to Aspect 19, further comprising combining a second portion of the non-condensable stream with the PSA feed stream prior to separation to produce the hydrogen product stream and the tail gas stream.

Aspect 21: A method according to Aspects 19 or 20, wherein a ratio of a flow rate of the at least a portion of the non-condensable stream contacted with the first shift catalyst to a total flow rate of the non-condensable stream is increased or decreased to decrease or increase a temperature of the first shifted syngas stream, respectively.

Aspect 22: A method according to Aspect 21, wherein the temperature of the first shifted syngas stream is maintained below a metal dusting limit temperature.

Aspect 23: A method according to any of Aspects 19 to 22, further comprising bypassing a portion of the second syngas stream around the first shift catalyst and combining the portion of the second syngas stream with the first shifted syngas stream prior to contacting with the second shift catalyst.

Aspect 24: A method according to Aspect 23, further comprising increasing or decreasing the portion of the second syngas stream bypassed around the first shift catalyst to decrease or increase a temperature of the first shifted syngas stream, respectively.

Aspect 25: A method according to any of Aspects 19 to 24, further comprising contacting at least a portion of the second shifted syngas stream with a third shift catalyst to produce a third shifted syngas stream; wherein the PSA feed stream comprises the third shifted syngas stream.

Aspect 26: A method according to any of Aspects 19 to 27, wherein a steam to dry gas ratio of the combined syngas stream is less than 2.0.

Aspect 27: A method according to any of Aspects 19 to 26, further comprising compressing the tail gas stream prior to cooling to 10 bar.

Aspect 28: A method according to any of Aspects 19 to 27, further comprising dehydrating the tail gas stream prior to cooling to less than 100 ppmv water.

Aspect 29: A method according to any of Aspects 19 to 28, wherein the non-condensable stream comprises less than 30% CO2 by volume.

Aspect 30: A method according to any of Aspects 19 to 29, wherein the CO concentration of the second syngas stream is greater than 15%.

Aspect 31: A method according to any of Aspects 19 to 30, wherein the sulfur concentration of the second syngas stream is less than 20 ppmv.

Aspect 32: A method according to any of Aspects 19 to 31, wherein the water concentration of the combined syngas stream ranges from 20% to 55% by volume.

Aspect 33: A method according to any of Aspects 19 to 32, further comprising removing a purge stream depleted in hydrogen from the at least a portion of the non-condensable stream by selective permeation prior to contacting with the first shift catalyst.

Aspect 34: A method according to any of Aspects 19 to 33, wherein a temperature of the combined syngas stream ranges from 550 ° F. to 650 °F.

### Example 1

A computer simulation of the process of FIG. 1 was carried out using Aspen Plus® process simulation software, available from Aspen Technology Inc and proprietary thermodynamic data. Two cases were compared that minimized the total operating cost of the plant for a given flow rate of hydrogen product given the constraint of 99% carbon capture. Case 1 delivered the first recycle stream 134 to the feed of the HTS reactor 140 while Case 2 delivered the first recycle stream 134 to the feed of the LTS reactor 160. Case 1 operates according to the present invention and Case 2 is a reference case showing recycle to the LTS in order to match the composition of the first recycle stream 134 to the shifted syngas as closely as possible. Case 2 does show a benefit of a 9% increase in total steam exported which demonstrates the thermodynamic advantage of recycling to the LTS. However, the outlet temperature of the HTS reactor 140 is 16 °F higher in Case 2 than Case 1, showing a reduction of risk of metal dusting in Case 1.

### Example 2

A computer simulation of the process of FIG. 1 was carried out using the same program and data as in Example 1 to demonstrate the effect of changing the fraction of the non-condensable stream recycled to the HTS with a constant SDGR at the inlet to the HTS equal to 0.84. Total operating cost was minimized. While the percentage of carbon dioxide captured was allowed to vary, the result ranged from 96 to 97% in all cases. For the base case 19% of the non-condensable gas was recycled to the HTS and resulted in an outlet temperature of the HTS of 876 ° F. A high and low recycle case (40% and 10%) resulted in an outlet temperature of the HTS of 861 ° F. and 883 ° F., respectively, demonstrating the ability to control outlet temperature of the HTS using the fraction of non-condensable stream recycled to the HTS.

### Example 3

The simulations of Example 2 were repeated with a lower SDGR at the inlet of the HTS equal to 0.36. The base case fraction of non-condensable gas recycled to the HTS was 58% resulting in an outlet HTS temperature of 857 ° F. A high and low recycle case (84% and 30%) resulted in an outlet temperature of the HTS of 845 ° F. and 872 ° F., respectively. While the low SDGR cases also demonstrated temperature control and thus metal dusting risk mitigation, there were also larger effects on the percentage of carbon dioxide captured: 96% in the base case, 98% in the high recycle case, and 94% in the low recycle case.

While the principles of the disclosure have been described above in connection with preferred embodiments, it is to be clearly understood that this description is made only by way of example and not as a limitation of the scope of the disclosure.

1. A method comprising:
reacting a feed stream comprising hydrocarbons with an oxidant comprising at least one of water, oxygen, and carbon dioxide to produce a first syngas stream comprising hydrogen, water, carbon monoxide, and carbon dioxide;
reacting a second syngas stream in the presence of a first shift catalyst to produce a first shifted syngas stream enriched in hydrogen and carbon dioxide and depleted in water and carbon monoxide;
reacting the first shifted syngas stream in the presence of a second shift catalyst to produce a second shifted syngas stream further enriched in hydrogen and carbon dioxide and depleted in water and carbon monoxide;
separating a PSA feed stream to produce a hydrogen product stream enriched in hydrogen and a tail gas stream depleted in hydrogen;
cooling the tail gas stream below a dew point temperature of the tail gas stream to produce a liquid stream enriched in carbon dioxide and a non-condensable stream depleted in carbon dioxide;
contacting at least a portion of the non-condensable stream with the first shift catalyst; and
wherein the second syngas stream comprises the first syngas stream or a stream derived from the first syngas stream;
wherein the PSA feed stream comprises the second shifted syngas stream or a stream derived from the second shifted syngas stream.

2. The method of claim 1, further comprising combining a second portion of the non-condensable stream with the PSA feed stream prior to separation to produce the hydrogen product stream and the tail gas stream.

3. The method of claim 1, wherein a ratio of a flow rate of the at least a portion of the non-condensable stream contacted with the first shift catalyst to a total flow rate of the non-condensable stream is increased or decreased to decrease or increase a temperature of the first shifted syngas stream, respectively.

4. The method of claim 3, wherein the temperature of the first shifted syngas stream is maintained below a metal dusting limit temperature.

5. The method of claim 1, further comprising bypassing a portion of the second syngas stream around the first shift catalyst and combining the portion of the second syngas stream with the first shifted syngas stream prior to contacting with the second shift catalyst.

6. The method of claim 5, further comprising increasing or decreasing the portion of the second syngas stream bypassed around the first shift catalyst to decrease or increase a temperature of the first shifted syngas stream, respectively.

7. The method of claim 1, further comprising contacting at least a portion of the second shifted syngas stream with a third shift catalyst to produce a third shifted syngas stream;
wherein the PSA feed stream comprises the third shifted syngas stream.

8. The method of claim 1, wherein an overall steam to dry gas ratio of the second syngas stream and the at least a portion of the non-condensable stream is less than 2.0.

9. The method of claim 1, further comprising heating the at least a portion of the non-condensable stream by indirect heat exchange against the first shifted syngas stream prior to contacting at least a portion of the non-condensable stream with the first shift catalyst.

10. The method of claim 1, further comprising compressing the tail gas stream prior to cooling to 10 bar.

11. The method of claim 1, further comprising dehydrating the tail gas stream prior to cooling to less than 100 ppmv water.

12. The method of claim 1, wherein the non-condensable stream comprises less than 30% CO2 by volume.

13. The method of claim 1, wherein the CO concentration of the second syngas stream is greater than 15%.

14. The method of claim 1, wherein the sulfur concentration of the second syngas stream is less than 20 ppmv.

15. The method of claim 1, wherein the combined water concentration of the second syngas stream and the at least a portion of the non-condensable stream ranges from 20% to 55% by volume.

16. The method of claim 1, further comprising removing a purge stream depleted in hydrogen from the at least a portion of the non-condensable stream by selective permeation prior to contacting with the first shift catalyst.

17. The method of claim 1, wherein the at least a portion of the non-condensable stream is initially contacted with the first shift catalyst at a point downstream of where the second syngas stream initially contacts the first shift catalyst.

18. The method of claim 1, wherein a temperature of the second syngas stream ranges from 550 ° F. to 650 °.F.

19. A method comprising:
reacting a feed stream comprising hydrocarbons with an oxidant comprising at least one of water, oxygen, and carbon dioxide to produce a first syngas stream comprising hydrogen, water, carbon monoxide, and carbon dioxide;
contacting the first syngas stream with a liquid wash stream to produce a second syngas stream;
heating the second syngas stream by indirect heat exchange against a first shifted syngas stream to produce a heated syngas stream;
combining the heated syngas stream with steam and a recycle stream to produce a combined syngas stream;
reacting the combined syngas stream in the presence of a first shift catalyst to produce the first shifted syngas stream enriched in hydrogen and carbon dioxide and depleted in water and carbon monoxide;
reacting the first shifted syngas stream in the presence of a second shift catalyst to produce a second shifted syngas stream further enriched in hydrogen and carbon dioxide and depleted in water and carbon monoxide;
separating a PSA feed stream to produce a hydrogen product stream enriched in hydrogen and a tail gas stream depleted in hydrogen; and
cooling the tail gas stream below a dew point temperature of the tail gas stream to produce a liquid stream enriched in carbon dioxide and a non-condensable stream depleted in carbon dioxide;
wherein the recycle stream comprises at least a portion of the non-condensable stream;
wherein the PSA feed stream comprises the second shifted syngas stream or a stream derived from the second shifted syngas stream.
